(19) United States
(12) Patent Application Publication
(10) Pub. No.: US 2005/0198139 A1
(43) Pub. Date: Sep. 8, 2005

(54) Multispeaker presentation system and method

(75) Inventors: Peter K. Malkin, Ardsley, NY (US); Alex Ruskewich, Wilton, CT (US); Tracee Wolf, Irvington, NY (US)

Correspondence Address: SCULLY SCOTT MURPHY & PRESSER, PC, 400 GARDEN CITY PLAZA, SUITE 300, GARDEN CITY, NY, 11530, US

(73) Assignee: INTERNATIONAL BUSINESS MACHINES CORPORATION, ARMONK, NY (US)

(21) Appl. No.: 10/787,014

(22) Filed: Feb. 25, 2004

(51) Int. Cl. G06F 15/16

(52) U.S. Cl. 709/205

(57) ABSTRACT

A system and method for conducting an online multi-speaker presentation comprises the implementation of a presentation agenda that specifies a plurality of phases, each phase having a speaker for presenting in a pre-specified order; and the agenda including policies for coordinating data feeds to one or more client devices according to an activated phase. Data feeds for audio, video, audio-visual or non-speaker data sources are provided to one or more clients and activated in accordance with an agenda phase policy, the data feeds being triggered automatically upon new phase activation. Thus, many users of the on-line meeting participate according to feed policies specified by said agenda without users at the client devices having to explicitly select or coordinate the feed controls during the presentation.

### BACKGROUND OF THE INVENTION

1. Field of the Invention

The present invention relates generally to online conference session presentation systems and methods and particularly, a novel method and system for conducting an online presentation including multiple speakers.

2. Description of the Prior Art

It often happens that online conference sessions are fraught with the complexity of coordinating the technical aspects of screen sharing and passing on the permissions of screen manipulation during an online conference session as well as aligning these controls according to a sequentially planned meeting. Transitioning from one phase of the sequence to another involves switching controls from one speaker to another and/or switching from one application to another in the course of a presentation. These transitions involve technical attention on the part of the presenter(s), typically disruptive to the presenter's message.

Many technical and graphical solutions have been developed which address these challenges. For instance, “Sametime Meeting”, a product of I.B.M./Lotus, is an online presentation solution that allows users to share their screens or applications to an online audience. When another member of the electronic or online meeting (“eMeeting”) would like to share their screen or application, the current presenter has to give up his or her control and the other member has to take the control. This change of control usually is accompanied by a disruptive discussion about coordinating the transition or a disruptive pause in the presentation. Also, Sametime Meeting does not have the ability to set up a sequence of control switches between users or between applications in a predetermined way. Similar to Sametime Meeting, the Multimedia and Multi-party Desktop Conference System (“MERMAID”) is a system allowing a group of remotely located users to conduct a meeting via their desktop computers. The user with the floor control determines that his or her inputs are sent to the audience while muting audiences' input controls. Floor control can also be passed in order of the requests for the floor. Although this invention provides a means to designate which user has control of the data flow, it does not provide a meeting agenda-based means to do this, nor does it provide a dynamically updated, meeting-phase-based user interface to pass this control.

U.S. Pat. No. 6,496,201 B1 entitled “System and User Interface for Multiparty Conferencing,” describes a system and GUI for teleconferencing. The invention describes modes, which allow the invention to incorporate other conferencing systems (e.g., a speed dialing menu, a directory server listing, or a call log history). The GUI focuses on the system modes and features, not on phases of a meeting, and the system does not provide a way to sequentially switch between the resources of the different speakers of a meeting depending on which phase is current.

Currently-pending, commonly-owned U.S. patent application Ser. No. ______ (Attorney Docket No. YOR9-2003-0090-US1) entitled “Agenda-Driven Meetings” relates to a system for structuring an “agenda-driven meeting” that allows a distributed work group, committee, or task force to have an online meeting to review the status of various ongoing projects. The feature of the invention described in commonly-owned U.S. patent application Ser. No. ______ is an “agenda” comprising a list of items that defines a meeting phase. Social interaction coherence through the use of awareness mechanisms is supported and a graphical interface depicting group activity is provided. Phases are distinct areas of interest within the meeting, but they need not be sequential, and the transition from one to another does not involve any passing of feeds or controls from one person to another.

Therefore, a need exists for a method of coordinating direct feed control manipulation based of the phase (or section) of a given meeting, where the feeds are automatically reconfigured when a new phase begins, and where these feed configurations can be specified (e.g., in an agenda) before the meeting beings. There also exists a need for an eMeeting graphical representation, which depicts both the current eMeeting phase and floor control.

### SUMMARY OF THE INVENTION

The current invention provides a system and method that coordinates the data feeds of a given online meeting (an eMeeting) with the meeting's section or phases. In particular, it is the agenda of a given eMeeting to not only specify the phases of the given meeting, but additionally how the data feeds of the participants of the eMeeting will be directed. These feeds include the audio and video from each of the eMeeting's participants, as well external data source as well (e.g., an external video or audio feed).

In addition, the current invention also provides eMeeting participants with a dynamically updated, graphical user interface (GUI), and one that gives an abstract representation of the current meeting state. In addition to supporting the eMeeting's agenda and social coherence, this GUI acts an interface between the meeting's agenda and the data feed configurations. When the meeting chairperson or current speaker wants to switch the eMeeting's feed configuration from that of the current phase to the next, he or she can simply select (or “click on”) the relevant object in the graphic representation. The invention then automatically reconfigures the eMeeting's data feeds to those of the next phase. The current invention also enables eMeeting speakers and spectators to handle the feed reconfigurations associated with question and answer sessions, the inventive GUI functioning as the front-end.

### BRIEF DESCRIPTION OF THE DRAWINGS

Further features, aspects and advantages of the apparatus and methods of the present invention will become better understood with regard to the following description, appended claims, and the accompanying drawings where:

FIG. 1 is a diagram depicting an example online eMeeting agenda according to the present invention;

FIG. 2 is a diagram depicting an example network topology according to one embodiment of the present invention;

FIG. 3 is a block diagram depicting components of the server device implemented according to an example embodiment of the invention;

FIG. 4 is an example multi-speaker presentation logic flow diagram depicting operation of the server device implemented according to an embodiment of the invention;

FIG. 5 is a diagram depicting an example graphical user interface implemented according to an embodiment of the invention; and,

FIG. 6 is a flow diagram depicting the eMeeting agenda according to an embodiment of the invention.

### DETAILED DESCRIPTION OF THE PREFERRED EMBODIMENT

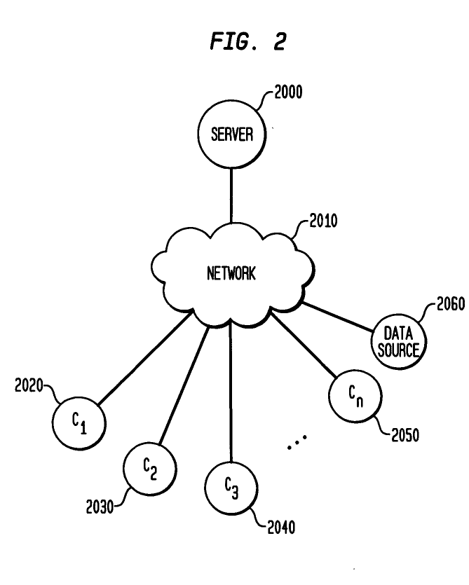

The present invention is implemented to support a meeting conducted online (eMeeting). According to this aspect invention, the various eMeeting feeds (data sources) are coordinated with the meeting's agenda, enhancing the eMeeting's flow of presentation by minimizing technical coordination from one agenda item (or speaker) to another. A further aspect of the invention provides a novel graphical user interface for illustrating the current eMeeting state and providing additional feed-management control. The current embodiment implements a web (HTTP) service model, with a web (HTTP) server (described in detail with reference to FIGS. 2, 4 and 6) accepting data from and providing data to running one or more web clients (described in detail with reference to FIG. 2).

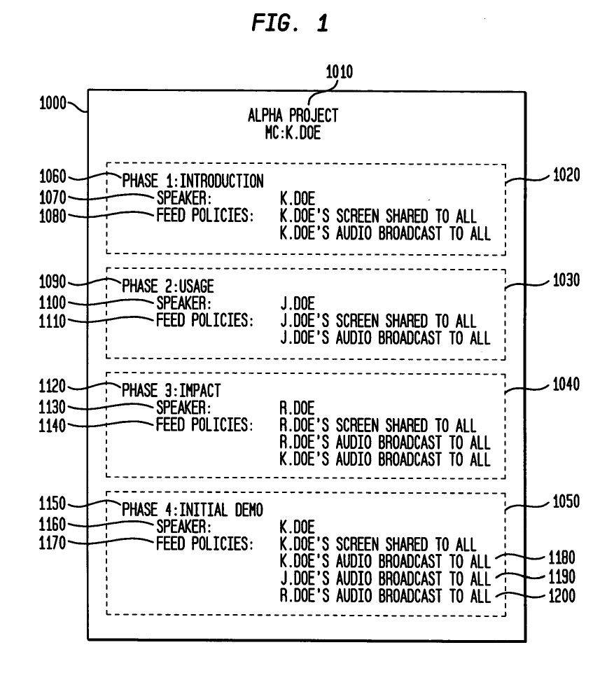

FIG. 1 depicts the preferred embodiment's agenda 1000, which specifies what will happen in a given meeting and when, including the meeting phases, and each phase's speaker. In addition, each of the agenda's phase-entries 1020-1050 includes a feed policy (1080, 1110, 1140 and 1170, respectively) that specifies which data feeds will be broadcast during the phase and to whom. The agenda 1000 has a title 1010, indicating the topic of the meeting. The agenda 1000 also has phases (1020, 1030, 1040, 1050), indicating the subtopics to be covered in the meeting and the order in which they are to be presented. Each phase has a subtopic name (1060, 1090, 1120, 1150), indicating the title of the phase. Speakers are associated with each phase (1070, 1100, 1130, 1600). Each phase also has a feed policy associated with it (1080, 1110, 1140, 1170) indicating whose screen will be shared and whose audio will be broadcast during each phase, and to whom the broadcasts are to be sent. A feed policy could also indicate that feed from a non-speaker-related source be broadcast, an example of such a source being web-accessible streaming video (e.g., a publicly broadcast lecture), or web-accessible streaming audio (e.g., an online radio station).

This agenda 1000, including its phases, speakers and feed policies are all determined and specified at some point in time before the meeting begins. The agenda 1000 can be implemented as a simple text file, created with tools including, but not limited to, the Notepad applications included Microsoft Windows, or Vi distributed with the UNIX operating system. The current invention is additionally applicable to cases where the agenda is embodied in other ways, such as an instance of the software object (e.g., an instance of a Java-based object). When the meeting advances from one phase to the next, the associated speaker and feed policies will be triggered automatically without explicit technical adjustment of floor control during the meeting itself. One with ordinary skill in the art will appreciate that default feed policies can also be specified, e.g., that barring any other policy, no user will provide any feed, or that both the current speaker's audio and video are broadcast. Similarly, a default could specify that the current speaker have floor control (i.e., the right and ability to change the current meeting phase). Additionally, the agenda could specify a meeting leader (e.g., a chairperson, or emcee role) and give this role particular rights (e.g., the chairperson would always have their audio broadcast to everyone).

So, given this agenda 1000, when the meeting moves, for example, from phase 3 onto phase 4, the feed policy switches from phase 3's 1140, to phase 4's 1170. This means that the users see the shared screen switch from R. Doe's screen to K. Doe's as shown in FIG. 1. It additionally means that users begin receiving an audio feed from J. Doe 1190, in addition to the audio feeds from K. Doe 1180 and R. Doe 1200. Note that the change from phase 3's feed-configuration to phase 4's is performed automatically without any users having to explicitly select or coordinate the feed controls during the presentation.

It is noted that, in the example online eMeeting scenario depicted in FIG. 1, in both phases 3 and 4, multiple audio feeds are specified. This means that all audio feeds indicated will be broadcast to all active users, their signals mixed together. It is understood that a variety of configurations are possible, for instance, one or more of the active users, other than the current speaker, could have their audio feeds muted (e.g., all users other than the current speaker have their audio muted), or, one or more of the active users, other than the current speaker, may have their (audio) feeds broadcast.

Those skilled artisans will appreciate that multiple video feeds could be specified as well; the intention being that all active clients would receive all indicated feeds at once. The server device 2000 as shown in FIG. 2, capable of handling the combination of the multiple feeds in a single composite image, using its own arrangement algorithm, or the feed policy may indicate the arrangement explicitly. For example,
Phase n: XX YYYY ZZZZZ
Speaker: Ms. A. BBBBB
Feed Policies: BBBBB's screen broadcast to all; top-left-hand quarter of image XX video feed broadcast to all; bottom-right-hand quarter of image.

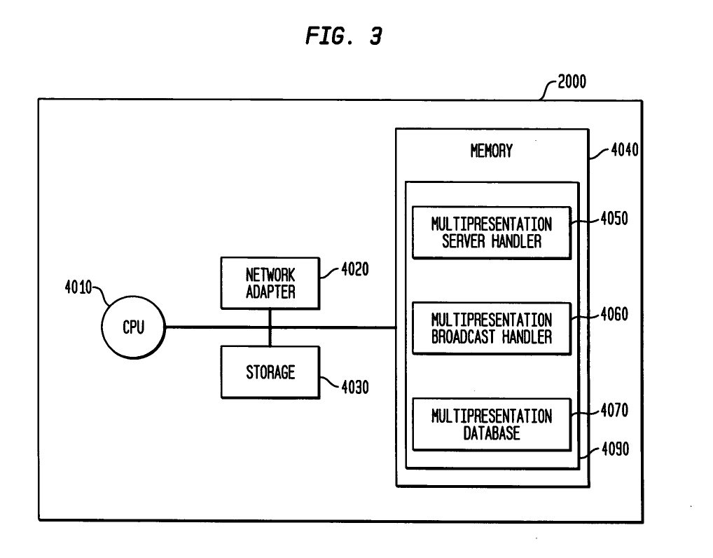

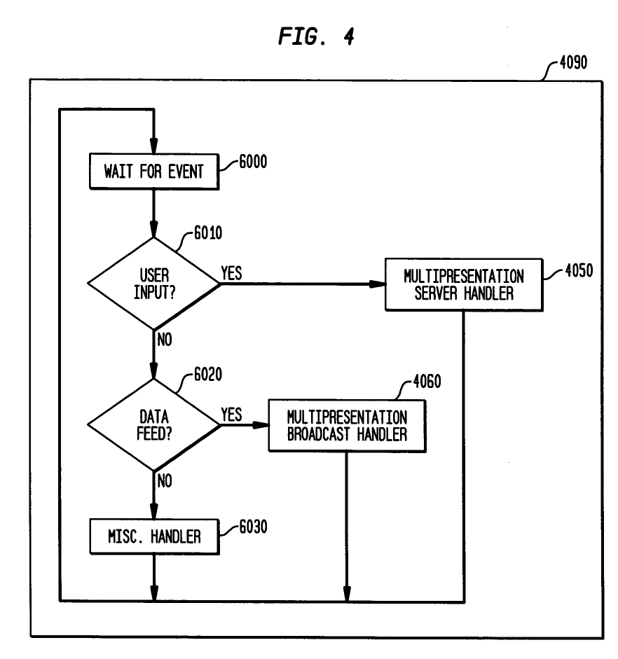

FIG. 2 describes the network topology for supporting the online eMeeting agenda of the present invention. As shown, a server device 2000, which will be described in greater detail with respect to FIGS. 3 and 4, and client devices, including network nodes such as workstations, personal computing devices, mobile PCs, etc. 2020, 2030, 2040, 2050 are all connected to a network 2010, through which they communicate. Although only four clients are shown in FIG. 2, however, it is understood that the present invention is applicable to any number of clients. FIG. 2 additionally illustrates a data source 2060 connected to the network 2010. This can be any source of that is able to transmit its data over the network 2060. Examples of such source include one providing streaming video, e.g., Stanford University's online courses (see http://www-pcd.stanford.edu/cs547/online.html for details), or online streaming audio, e.g., Colorado Public Radio (see http://cpr.org/listen/ for details).

The server device 2000 may be any computing node able to act as an HTTP server. This includes, but is not limited to, the products sold by IBM under the trademarks ThinkPad® or PowerPC®, running the operating system and server application suite sold by Microsoft under the trademark Windows NT®. Examples of the network 2010 include, but are not limited to, the Internet and private intranets. Each client 2020, 2030, 2040, 2050 may include any network node able to act as an HTTP client. Examples include, but are not limited to, an IBM ThinkPad® running Windows 95 and a web browser such as Microsoft's Internet Explorer®. Clients also include network-connectable mobile (i.e., portable) devices such as that sold under the trademark WorkPad® by IBM, as well as smart cellular telephones (i.e., devices which can act as a cellular telephone as well as run network applications, like web browsers), for instance, as those sold by Nokia such as the Nokia 90008.

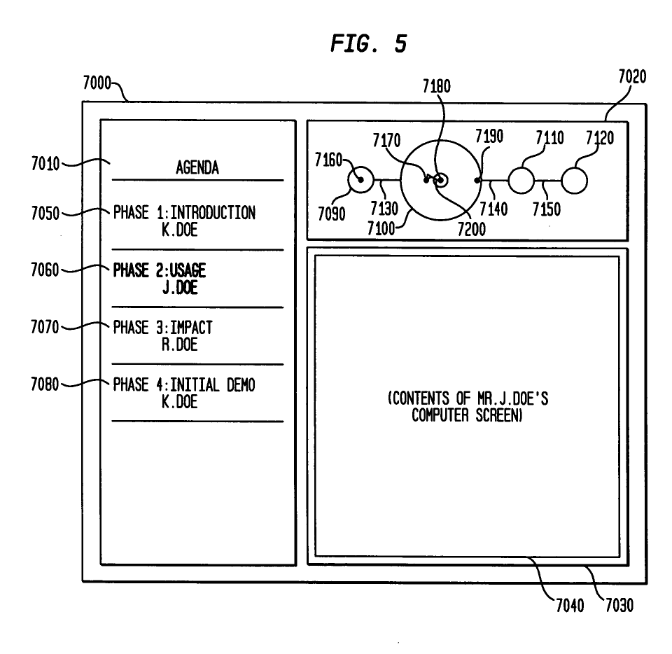

In the preferred implementation, the client application includes an applet retrieved from the server 2000, and run via the client's HTTP client (web browser). This applet provides the following functions: 1) Allows a given user to connect to a given meeting and indicate their identity (especially important for users who are speakers); 2) Transmits the feeds generated by the client (2020-2050), including audio and video, to the server 2000; 3) Outputs this feeds transmitted from the server 2000 to the active user; and, 4) Transmits control signals (e.g., the request to ask a question, an action described in detail with reference to FIG. 5) generated by the active user to the server 2000.

Additionally, in the preferred implementation, this applet, in addition to handling data display and user interactions (e.g., data entry and mouse events), constantly polls the server (2000) for updated data, this data being the latest version available for the meeting instance currently being viewed. Those with ordinary skill in the art will appreciate that there are other methods of retrieving such data, including, but not limited to having the server push updates, whenever available down to the client, the client listening on a port known to the server (for details, see Douglas Corner, “Internetworking with TCP/IP, Vol. 1 Principles, Protocols and Architecture,” Prentice Hall, Englewood Cliffs, N.J., 1991, incorporated by reference herein).

FIG. 3 depicts a more detailed example of the server 2000, which hosts the online multi-speaker presentation environment. The server 2000 preferably includes a CPU 4010, a network adapter 4020, a storage device 4030 such as a disk or DASD, and memory 4040, such as RAM. According to the present invention, the multi-speaker presentation logic 4090 (which will be discussed in more detail with reference to FIG. 4), is preferably embodied as computer executable code that is loaded from remote (e.g., over the network 2010 via the network adapter 4020) or local permanent optical (CD-ROM) or magnetic storage such as disk, or DASD 4030 into memory 4040 for execution by CPU 4010. The memory 4040 preferably includes a Multipresentation Server Handler 4050 (discussed in detail with reference to FIG. 4), a Multipresentation Broadcast Handler 4060 (discussed in detail with reference to FIG. 4), and a Multipresentation Database 4070.

The Multipresentation database 4070 may be any application providing access and persistent management of data, such as that sold by IBM under the trademark DB/2®. Those with ordinary skill in the art will also appreciate that the Multi-Speaker database 4070 may be run on another remote network connected node and accessed via the network 2010.

FIG. 4 depicts an example of the Multi-speaker presentation logic 4090 implemented by the server device shown in FIG. 3, i.e., the server's control flow. As shown, the server 2000 awaits input in step 6000, and then checks whether the input is a control signal from a client in step 6010. If the input is a control signal from a user, then the Multipresentation Server Handler 4005 is called, following which control resumes at step 6000.

The Multipresentation Server Handler 4005 can include a standard HTTP Server, such as the product sold by the IBM under the trademark WebSphere®. In addition, the Multipresentation Server Handler 4005 must include facilities to respond to the multi-speaker presentation user control requests. Means for augmenting the standard HTTP server include, but are not limited the use of CGI-bin scripts and Java Servlets.

The multi-speaker presentation user control requests, include, but are not limited to, the following: 1) Requests to create new multi-speaker presentation instances, including the specification of the presentation's agenda; 2) Requests to join a meeting, possibly including identification of the user; 3) Requests to exit a meeting; 4) Requests to ask a question (discussed in detail with reference to FIG. 5); 5) Providing indications that a given user can now ask their question (discussed in detail with reference to FIG. 5) in response to receipt of a request to ask a question; and, 6) Requests to change the presentation's phase (e.g., to the next phase in the agenda).

If the control signal request is one to create a new multi-speaker presentation instance, the Multipresentation Server Handler 4005 creates a new presentation entry in the Multipresentation Database 4070, parsing and storing the passed agenda in this new entry. If the request is one from a user asking to join an existing presentation, the Multipresentation Database 4070 takes the user ID for the requestor and stores it in applicable Multipresentation Database 4070 presentation entry, marking the user as active. If the request is one to leave a meeting, then the user's ID is deleted from the Multipresentation Database 4070 as being an active user. If the request is from an active user who wants to ask a question, then the user's entry in the applicable Multipresentation Database 4070 presentation is marked as requesting a question. One with ordinary skill in the art will appreciate that a given user can delete a request to ask a question in the same manner. If the input is an indication from the current speaker to a specified user that he or she may now ask their question, then the Multipresentation Database 4070 is first checked to verify that the specified user actually asked a question. If so, then that user is marked as the temporary current speaker in the applicable Multipresentation Database 4070 entry. According to the current invention, the current speaker may retain floor control to the extent that he or she may retract this temporary speaker status if necessary. One with ordinary skill in the art will appreciate that a presentation default could enable users with temporary speakers status to have their audio broadcast to all current active users.

Finally, if the request is one to change the presentation's current phase, the Multipresentation Server Handler 4005 first checks the agenda to verify that the user making the request has the privilege to do so. If so, the Multipresentation Server Handler 4005 checks the agenda to verify that the requested phase change is legal (e.g., moving on to the next phase listed in the agenda). If so, the Multipresentation Server Handler 4005 modifies the applicable Multipresentation Database 4070 presentation entry, marking the next phase as being the current one.

If the input is not a user control request, then, in step 6020, the input is checked to see whether it is a data feed. If not, then a miscellaneous handler, beyond the scope of the current invention, is invoked in step 6030, following which control continues at step 6000.

If the input is data feed, then the Multipresentation Broadcast Handler 4060 is invoked, following which control continues at step 6000. The Multipresentation Broadcast Handler 4060 is responsible for taking data that is fed from the clients 2020-2050 and data sources 2060, checking the current feed policy (1080, 1110, 1140, or 1170), combining the feeds as is specified, and then transmitting the resulting composite image and/or audio to the applicable clients 2020-2050.

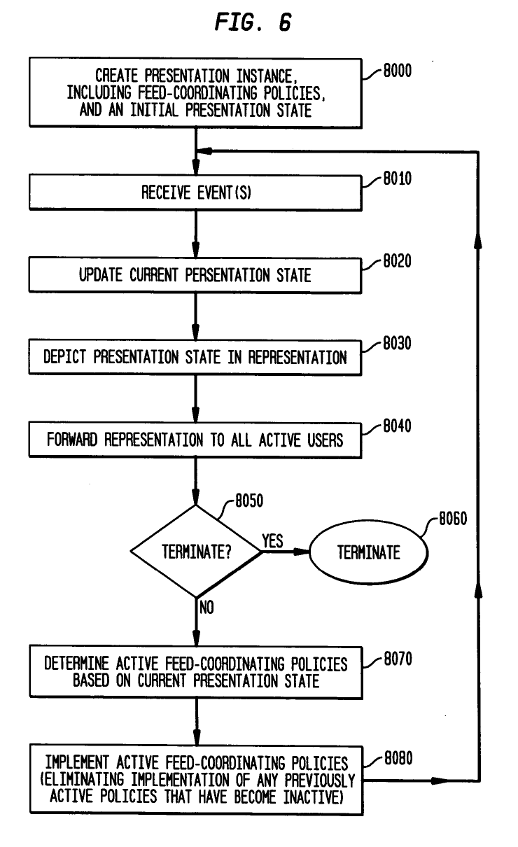

FIG. 5 depicts a user interface 7000 consisting of three interrelated parts: an agenda panel 7010, a representation panel 7020), and a display panel 7030. Within the display panel 7030 is a shared screen area 7040 where the contents of the meeting broadcast composite image is displayed to applicable users at their client devices. This composite image may comprise the current presenter's screen with the shared broadcast including not only a feed of the current speaker, but other services as well, e.g., slides, simulation, or video, as specified in the agenda. The contents of the shared screen area 7040 are coordinated and determined by the agenda panel 7010. Phases of the meeting 7050, 7060, 7070, 7080 are listed in the agenda provided for display in agenda panel 7010. Although only four phases are shown in FIG. 5, the present invention is applicable to any number of phases. Each phase 7050, 7060, 7070, 7080 includes a title and indicates a speaker. The current phase is depicted in bold 7060 or some other unique identifier. FIG. 5 additionally illustrates that the example meeting depicted is in its second phase. When the meeting is ready to advance to another phase, such as the third phase, the current speaker clicks on phase 3 7070 at which time, control feeds trigger appropriate audio and display permissions (as described in FIG. 6). That is, the graphic representation itself may be used to select the current section, or alternately, a user may select the current section via the agenda listing 7010.

The representation panel 7020 includes a depiction of the state of the presentation instance, including the current meeting agenda phases 7090, 7100, 7110, 7120; and all active users 7160, 7170, 7180, 7190 attending the meeting. The meeting agenda is depicted as a linear progression through phases, which are associated with the phases 7050-7080 in the agenda panel 7010. FIG. 5 illustrates four circles 7090, 7100, 7110, 7120 that correspond with the phases 7050-7080 outlined in the example agenda panel 7010 respectively. The first phase 7090 is shown grayed out, indicating that it has already been presented. In cases in which the presentation is persistent (i.e., archived or recorded), the content of that phase may be replayed at any time. The second phase 7100 is larger than the others, indicating the current phase that is being presented. The phases are connected with lines 7130, 7140, and 7150 to suggest the sequential nature of the agenda. It should be understood that, with respect to subsequently replaying an archived presentation (e.g., recorded), the archived presentation data may be replayed for viewing in a separate pop-up, floating screen, that includes playback controls. Preferably, previous presentation sections may be replayed while later sections are being presented.

All active users are depicted in the representation panel 7020 that graphically depicts an indication of the activity level of all active users. For instance, FIG. 5 shows users 7160-7190 graphically represented as colored dots that may be mouse-selected for details. Invited users who are not attending a current meeting might additionally be depicted in the representation. Preferably, the representation indicates a given active user's focus of attention, e.g., it shows which presentation section they are watching, including previous, current and future sections. For instance, as shown in FIG. 5, three (3) users 7170, 7180, and 7190 are attending the current phase of the presentation 7100. User 7180 is in the center of phase 2, depicting his/her role as speaker. User 7180 is depicted near the outer edge of the circle, indicating that he/she is in a dormant or listening state. User 7170 is near the inner edge of the circle, indicating that he/she is active or recently active. This user 7170 has a ‘flag’ 7200 attached to it, which indicates that this person has requested a question and would like to be called upon to speak when there is an opportune time in the presentation. The ‘flag’ 7200 might also be used to signify other kinds of intentions such as an affirmative vote. User 7160 is depicted within phase one 7090, indicating that he/she is reviewing material presented in an earlier phase. Accordingly, the representation depicted in FIG. 5 additionally includes summaries (e.g., of one or more sections or of the entire presentation).

The present invention provides a method by which data feed controls are created and activated, this activation tied to the current active phase of an online eMeeting. This process is depicted in FIG. 6. As shown, the first step 8000 is to create a presentation instance, which includes specifications for feed-coordinating policies and an initial presentation state. As described with reference to FIGS. 1 and 4, this information is specified in the form of agenda 1000. Next, in step 8010, the server 2000 receives data feeds from clients 2020-2050 and other data sources 2060, as well as user control requests (e.g., requests to join a meeting or ask a question). In step 8020, the server 2000 updates state of the eMeeting (e.g., adding a new user), and then, in step 8030, updates the eMeeting's graphical representation 7000. Next, in step 8040, the server sends the latest representation 7000 to all active users 2020-2050. The state of the eMeeting is then checked in step 8050, and if the eMeeting is complete, the eMeeting terminates in step 8060. Otherwise, the server 2000 determines the current active feed policy (1080, 1110, 1140, or 1170) in step 8070. Next, in step 8080, the server 2000 combines all applicable data feeds as specified by the applicable policy (1080, 1110, 1140, or 1170) and then broadcasts the resulting combined audio and video feeds to the applicable clients (one or more of 2020-2050). Following this, control continues at step 8010 where the server awaits further events.

Although the preferred embodiment is a web service (i.e., HTTP-bases), one with ordinary skill in the art will appreciate that the current invention can also be implemented as a videoconference, or as a raw socket-based client/server application.

While the invention has been particularly shown and described with respect to illustrative and preformed embodiments thereof, it will be understood by those skilled in the art that the foregoing and other changes in form and details may be made therein without departing from the spirit and scope of the invention which should be limited only by the scope of the appended claims.

1. A method for conducting an online multi-speaker presentation comprising the steps of:
receiving a presentation agenda that specifies a plurality of phases, each phase having a speaker for presenting in a pre-specified order; said agenda including a policy for coordinating data feeds to one or more client devices according to an activated phase;
controlling data feed configurations associated with each phase by activating data feed controls at times associated with an active agenda phase policy; and,
broadcasting data content from said feeds associated with a current phase to one or more connected client devices, whereby many users of the on-line meeting participate according to feed policies specified by said agenda without users at the client devices having to explicitly select or coordinate the feed controls during the presentation.

2. The method as claimed in claim 1, further including repeating steps of b)-c) for each successively activated phase until said agenda terminates.

3. The method as claimed in claim 1, wherein said data feeds comprise data audio and video feeds, said step of controlling data feed configurations associated with each phase further comprises the steps of:
checking a current agenda-phase policy; and,
combining data feeds as specified according to said current agenda-phase policy prior to broadcasting a resulting composite video and/or audio to applicable clients, whereby data feed controls are automatically activated according to an agenda phase policy associated with a new phase activation

4. The method as claimed in claim 1, further comprising the steps of:
generating a graphic representation of the instant state of the presentation, whereby the graphic representation includes a depiction of a current phase; and,
forwarding said representation to active users at said one or more client devices, each said one or more client devices adapted for receiving and displaying said graphic representation.

5. The method as claimed in claim 4, further comprising the step of: selecting a new phase whereby the selection is made via said graphical representation provided at that user's client device.

6. The method as claimed in claim 4, further including steps of:
determining a current active presentation state; and,
updating the graphical representation depicted according to said determined state and broadcasting a latest graphical representation to active users.

7. The method as claimed in claim 3, further comprising the step of: receiving a user control request to join an on-line multi-speaker presentation or exit said multi-speaker presentation, and, automatically activating or deactivating an audio or video feed for said user accordingly.

8. The method as claimed in claim 3, further comprising the step of: receiving a user control request to change the presentation's phase to a next phase in the agenda

9. The method as claimed in claim 3, further comprising the step of: receiving a user control request to create a new multi-speaker presentation instance including specification of the presentation's agenda.

10. The method as claimed in claim 3, further including the step of: enabling a current speaker to call on another active user who has requested to ask a question, whereby calling on another active user includes activating that user's audio feed.

11. The method as claimed in claim 10, wherein said step of calling on another active user includes the step of switching a shared screen to that another user's client device.

12. The method as claimed in claim 3, wherein said step of controlling data feed configurations further includes the step of accepting connections from speakers and spectators requesting to participate in said presentation.

13. The method as claimed in claim 1, further comprising: a step of authenticating speakers requesting to participate in said on-line meeting, said step of authenticating comprising the step of determining whether a given user can connect to the presentation.

14. The method as claimed in claim 13, further including the step of providing at least one user with broadcast rights, and enabling a user to take away one or more said broadcast rights.

15. The method as claimed in claim 13, wherein said authenticating comprises a step of implementing presentation access control in the form of an ID or password is given to a user.

16. An online multi-speaker presentation system comprising:
means for receiving a presentation agenda that includes a plurality of phases, each phase having an associated speaker, said agenda phase including a policy for coordinating data feeds to one or more clients at each phase;
a means for implementing data feed configurations to one or more clients in accordance with said agenda phase policy, and reconfiguring data feeds upon activation of a new phase, wherein a plurality of speakers of the on-line meeting participate according to feed policies specified by said agenda.

17. The online multi-speaker presentation system according to claim 16, further comprising a means for determining a current speaker and reconfiguring said data feeds according to an agenda phase specification of the current speaker.

18. The online multi-speaker presentation system according to claim 17, further comprising:
a communications network having a plurality of client devices connected thereto; and
a server means connected to said network for implementing said data feed configurations to one or more clients in accordance with said agenda phase policy, wherein said feed policies are triggered automatically without any client devices having to explicitly select or coordinate the feed controls during the presentation.

19. The online multi-speaker presentation system according to claim 18, wherein said data feeds are configured to communicate audio, video or combined audio and video data, said system including broadcast means for providing said audio or video or combined audio and video data associated with a phase to one or more connected client devices.

20. The online multi-speaker presentation system according to claim 19, wherein server means connected to said network further includes means for receiving data feeds from a client or data source, checking a current agenda-phase policy, and combining the feeds as is specified, said broadcast means transmitting a resulting composite image and/or audio to the applicable clients.

21. The online multi-speaker presentation system according to claim 18, wherein an agenda-phase policy specifies a data feed from a non-speaker-related data source be broadcast to one or more clients.

22. The online multi-speaker presentation system according to claim 21, wherein a non-speaker related data source includes web-accessible streaming video or streaming audio.

23. The online multi-speaker presentation system according to claim 21, wherein said agenda is implemented as a text file or as an instance of a software object.

24. The online multi-speaker presentation system according to claim 21, wherein said phases, speakers and feed policies of said agenda determined and specified at some point in time prior to commencement of said on-line meeting.

25. The online multi-speaker presentation system according to claim 21, further comprising: means for generating a graphic representation of the instant state of the presentation, whereby the graphic representation includes a depiction of a current phase, said server means forwarding said representation to active users at said one or more client devices adapted for receiving and displaying said graphic representation.

26. An on-line service for enabling multi-speaker presentations comprising
a communications network having a plurality of attached client devices adapted to receive broadcast presentations;
means connected to said communications network for receiving a presentation agenda that includes a plurality of phases, each phase having an associated speaker, said agenda phase including a policy for coordinating data feeds to one or more client devices at each phase for participating in said meeting; and,
a means for implementing data feed configurations to one or more clients in accordance with said agenda phase policy, and reconfiguring data feeds upon activation of a new phase, wherein said feed policies are triggered automatically without users at said clients devices having to explicitly select or coordinate the feed controls during the presentation.

27. The online service according to claim 26, further comprising means for receiving user control requests for participating in an on-line presentation, a user control request to change the presentation's phase to a next phase in the agenda.

28. The online service according to claim 27, wherein a user control request received is a request to create a new multi-speaker presentation instance including specification of the presentation's agenda.

29. The online service according to claim 28, wherein a user control request received is a request to join a multi-speaker presentation or exit said multi-speaker presentation, said implementing means enabling said requesting user to have an audio or video feed activated.

30. The online service according to claim 28, wherein said feed policy includes broadcast rights, said service varying a users rights based on a agenda policy.

31. The online service according to claim 30, further comprising:
means for depicting the state of the presentation instance according to a graphical representation for presentation to said clients, said graphical representation adapted for indicating a current phase of said presentation; and,
means for determining a current active presentation state and updating the graphical representation depicted according to said determined state and broadcasting a latest graphical representation to active users.

32. The online service according to claim 31, further comprising means enabling a user to select a current phase via said graphical representation.

33. The online service according to claim 30, wherein said means for implementing data feed configurations to one or more clients further accepts data feed connections from speakers and spectators viewing said presentation.

34. The online service according to claim 30, wherein said means for implementing data feed configurations to one or more clients further includes means enabling an active user to give control of a currently active screen to another user.

35. A program storage device readable by a machine, tangibly embodying a program of instructions executable by the machine to perform method steps for method for conducting an online multi-speaker presentation, said method steps comprising:
receiving a presentation agenda that specifies a plurality of phases, each phase having a speaker for presenting in a pre-specified order; said agenda including policy for coordinating data feeds to one or more client devices according to an activated phase;
controlling data feed configurations associated with each phase by activating data feed controls at times associated with an active agenda phase policy; and,
broadcasting data content from said feeds associated with a current phase to one or more connected client devices, whereby many users of the on-line meeting participate according to feed policies specified by said agenda without users at the client devices having to explicitly select or coordinate the feed controls during the presentation.

36. The program storage device readable by a machine as claimed in claim 35, further including repeating steps of b)-c) for each successively activated phase until said agenda terminates.

37. The program storage device readable by a machine as claimed in claim 35, wherein said data feeds comprise data audio and video feeds, said step of controlling data feed configurations associated with each phase further comprises the steps of:
checking a current agenda-phase policy; and,
combining data feeds as specified according to said current agenda-phase policy prior to broadcasting a resulting composite video and/or audio to applicable clients, whereby data feed controls are automatically activated according to an agenda phase policy associated with a new phase activation

38. The program storage device readable by a machine as claimed in claim 35, further comprising the steps of:
generating a graphic representation of the instant state of the presentation, whereby the graphic representation includes a depiction of a current phase; and,
forwarding said representation to active users at said one or more client devices, each said one or more client devices adapted for receiving and displaying said graphic representation.

39. The program storage device readable by a machine as claimed in claim 38, further comprising the step of: selecting a new phase whereby the selection is made via said graphical representation provided at that user's client device.

40. The program storage device readable by a machine as claimed in claim 38, further including steps of:
determining a current active presentation state; and,
updating the graphical representation depicted according to said determined state and broadcasting a latest graphical representation to active users.

41. The program storage device readable by a machine as claimed in claim 37, further comprising the step of: receiving a user control request to join an on-line multi-speaker presentation or exit said multi-speaker presentation, and, automatically activating or deactivating an audio or video feed for said user accordingly.

42. The program storage device readable by a machine as claimed in claim 37, further comprising the step of: receiving a user control a user control request to change the presentation's phase to a next phase in the agenda

43. The program storage device readable by a machine as claimed in claim 37, further comprising the step of: receiving a user control request to create a new multi-speaker presentation instance including specification of the presentation's agenda.

44. The program storage device readable by a machine as claimed in claim 37, further including the step of: enabling a current speaker to call on another active user who has requested to ask a question, whereby calling on another active user includes activating that user's audio feed.
